(19) United States
(12) Patent Application Publication
(10) Pub. No.: US 2018/0155951 A1
(43) Pub. Date: Jun. 7, 2018

(54) METHOD AND APPARATUS FOR CONSTRUCTING A CONCRETE TOWER

(71) Applicant: Tindall Corporation, Spartanburg, SC (US)

(72) Inventors: Bryant Zavitz, Conley, GA (US); Kevin Kirkley, Conley, GA (US)

(21) Appl. No.: 15/578,057

(22) PCT Filed: May 31, 2016
(86) PCT No.: PCT/US16/34994

§ 371 Date: Nov. 29, 2017

Related U.S. Application Data
(63) Continuation of application No. 15/168,284, filed on May 31, 2016, now abandoned.
(60) Provisional application No. 62/168,203, filed on May 29, 2015.

(51) Int. Cl. E04H 12/34; E04H 12/16; F03D 13/10; E04C 5/12; E04C 3/34; E04C 5/16

(52) U.S. Cl. CPC E04H 12/342; E04H 12/16; F03D 13/10; E04C 5/162; E04C 3/34; F05B 2240/912; E04C 5/12

(57) ABSTRACT

The present invention broadly comprises a method and apparatus for constructing a concrete tower. In one embodiment, a tower construction apparatus includes an alignment jig and a pre-cast concrete element located on the alignment jig.

### CROSS REFERENCE TO RELATED APPLICATIONS

This application claims priority to U.S. patent application Ser. No. 15/168,284, filed May 31, 2016 and under 35 U.S.C. § 119(e) to U.S. application Ser. No. 62/168,203, filed May 29, 2015, the entire content of each of-which is incorporated onto the present application by reference.

### FIELD OF THE INVENTION

The present invention relates to a method and apparatus for constructing a concrete tower. In particular, the invention relates to constructing a concrete tower using pre-cast concrete components.

### BACKGROUND OF THE INVENTION

Conventional methods and apparatuses for constructing a tower with pre-cast components can be labor intensive. Accordingly, a need for a more efficient method and apparatus has been developed by the present inventors.

### SUMMARY OF THE INVENTION

The present invention broadly comprises a method and apparatus for constructing a concrete tower. In one embodiment, a tower construction apparatus includes an alignment jig and a pre-cast concrete element located on the alignment jig.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 illustrates an embodiment of a concrete tower that can be constructed according to an exemplary embodiment of the present invention;

FIG. 2 illustrates close up view of portions of the concrete tower in FIG. 1;

FIGS. 3 and 4 illustrate a first exemplary process for making subassemblies for the tower shown in FIG. 1;

FIGS. 5-9 illustrate a second exemplary process for making subassemblies for the tower shown in FIG. 1;

FIGS. 10-14 illustrate an exemplary process for making the subassemblies for the tower shown in FIG. 1;

FIG. 15 illustrative several view of the element that make up the subassemblies;

FIG. 16 shows an embodiment of a form for creating the elements that make up the subassemblies;

FIG. 17 illustrates exemplary structures for joining the pieces; and

FIG. 18-21 show multiple embodiments of towers made in accordance with the present invention.

### DETAILED DESCRIPTION OF THE PREFERRED EMBODIMENTS

Reference is presently made in detail to exemplary embodiments of the present subject matter, one or more examples of which are illustrated in or represented by the drawings. Each example is provided by way of explanation of the present subject matter, not limitation of the present subject matter. In fact, it will be apparent to those skilled in the an that various moderations and variations can be made in the present subject matter without departing from the scope or spirit of the present subject matter. For instance, features illustrated or described as part of one embodiment can be used with another embodiment to yield a still further embodiment. Thus, it is intended that the present subject matter covers such modifications and variations as come within the scope of the disclosure and equivalents thereof.

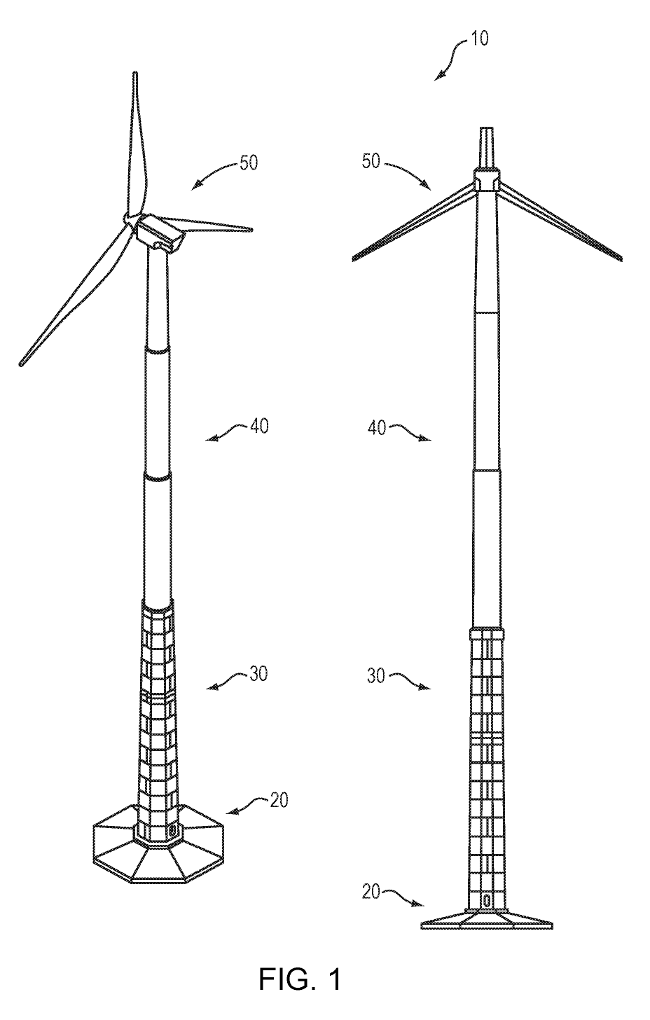

FIG. 1 shows a tower 10 built according to one embodiment of the present invention. Tower 10 includes a foundation 20, a concrete portion 30, a metal portion 40, and a wind turbine 50. However, towers used for purposes other than supporting wind turbines may be built in accordance with the present invention, and towers without any metal portion may also be built according to the present invention. Such modifications are within the scope of the invention as claimed.

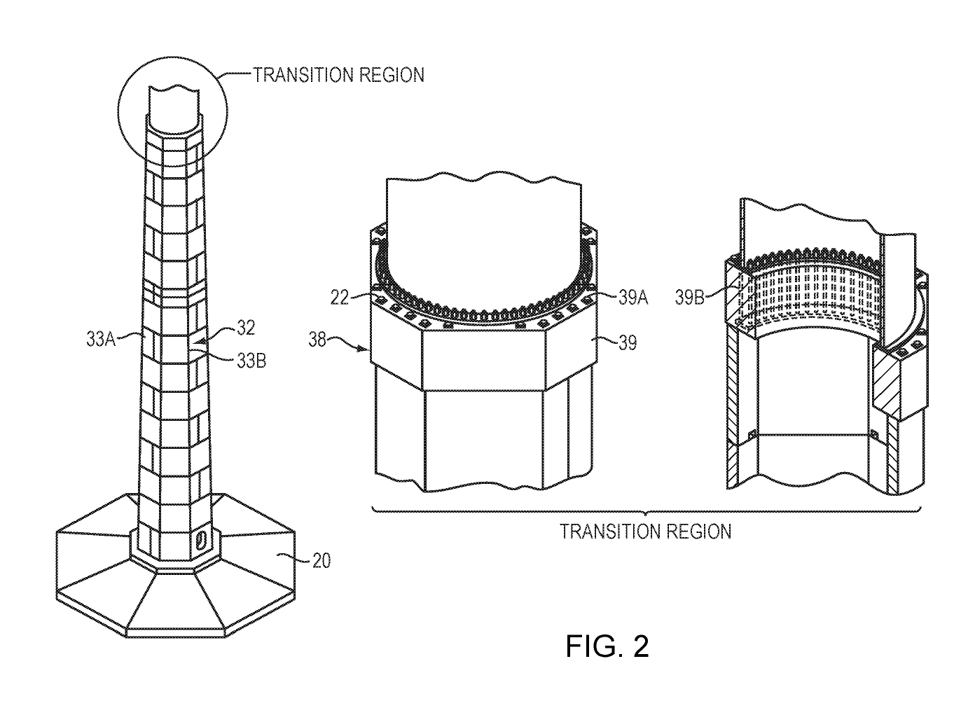

As shown in FIG. 2, the embodiment of the tower 10 shown in FIG. 1 may includes a concrete portion 30 including sections 32. In one embodiment, each section 32 is made of two precast elements, 33A and 33B. However, each section may be made of more than two elements. Concrete portion 30 also includes a transition region 38 in contact with the bottom of metal portion 40. Transition region 38 may include a precast transition ring 39 including a plurality of apertures 39A through which post tensioning strands 22 pass through. Post tensioning strands may be anchored in the foundation 20 and are capped off as they pass through apertures 39A.

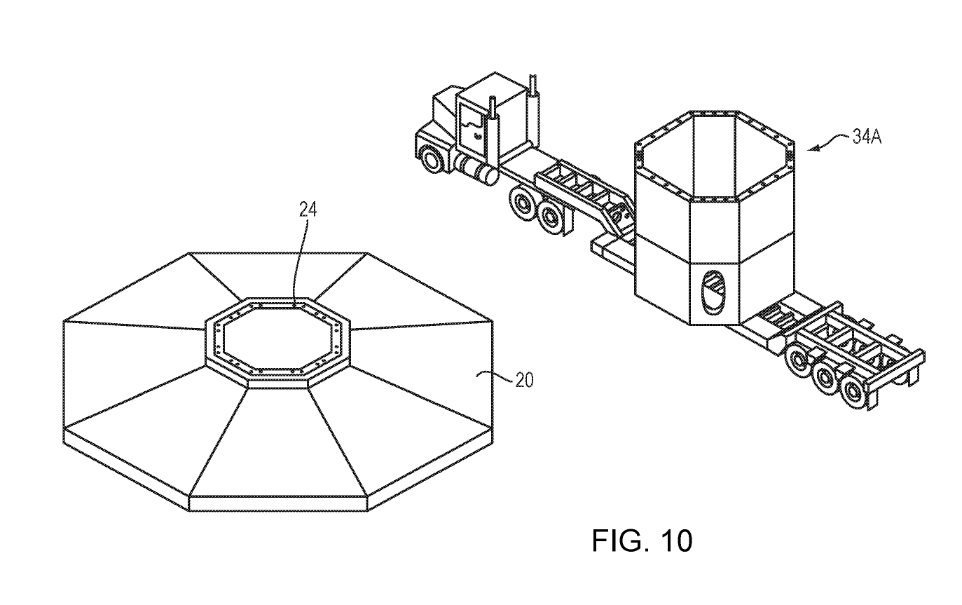

In another embodiment, a post-tensioning strand 22 is inserted into one of apertures 39A and fed through the aperture until it reaches the foundation level. An elbow passageway 24 in the foundation 20 (shown in FIG. 10) then guides the post-tensioning strand 22 up an adjacent aperture 39A. When the strand front end reaches the top of the adjacent aperture 39A, the strand in cut and each end is anchored on the top of transition ring 39 as shown in FIG. 2.

Transition ring 39 may also include a plurality of post tensioning rods 39B. These rods 39B extend through passages in transition ring 39 and a bottom flange of metal portion 40, and are capped off just above the flange of metal portion 40 and just below the surface of transition ring 39. This fixes the metal portion 40 to the concrete portion 30.

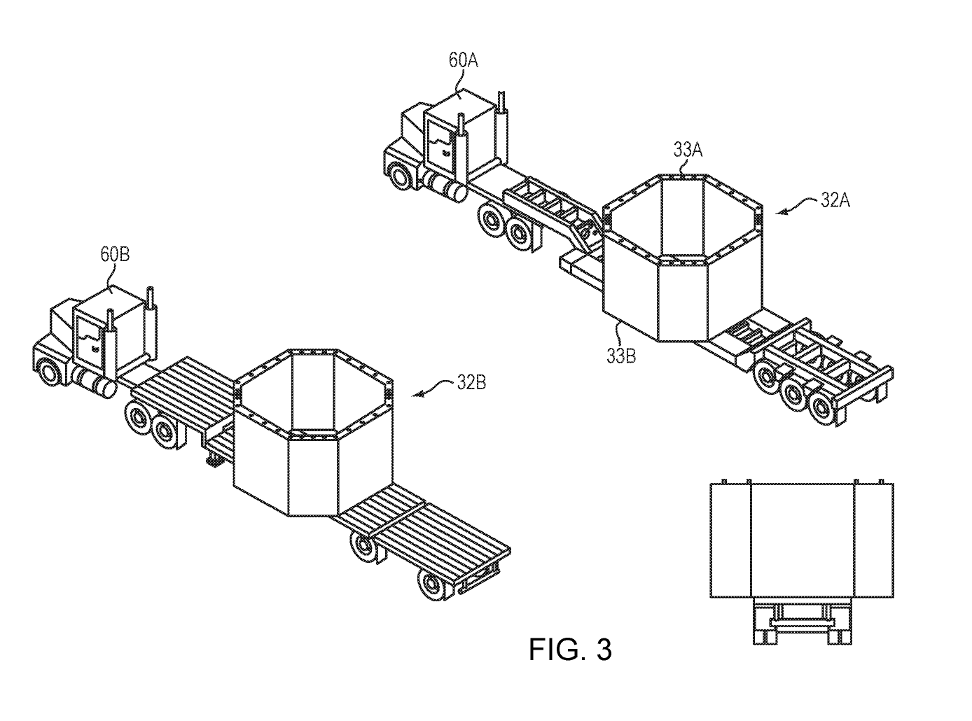

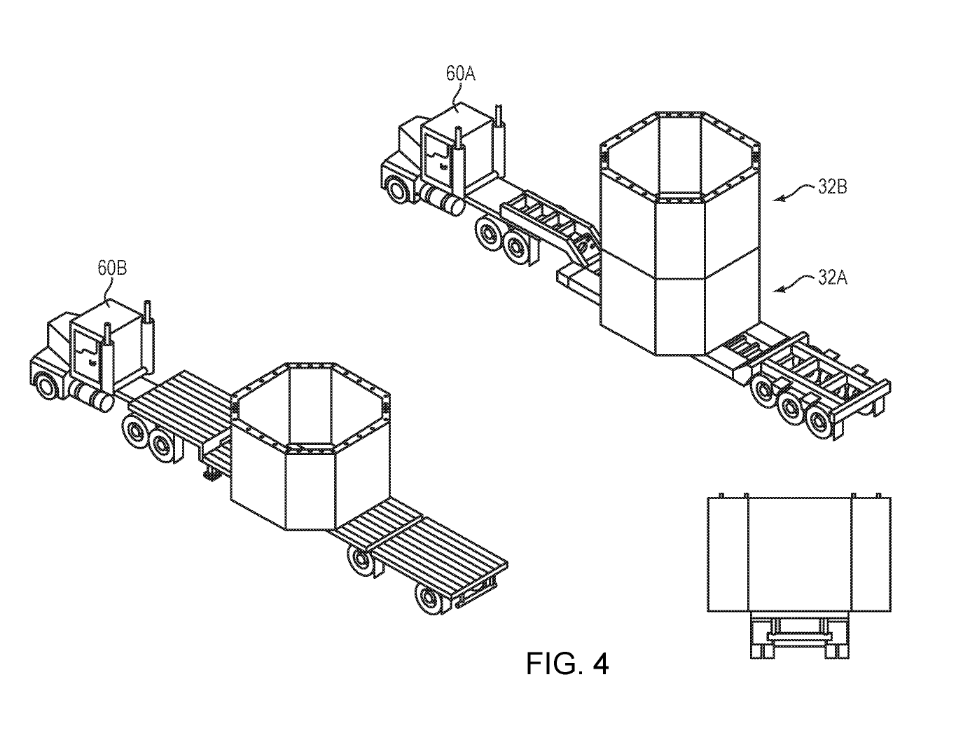

FIGS. 3 and 4 show a first embodiment for assembling sections 32. In FIGS. 3 and 4, each section 32 is made of two element 33A and 33B which are sealed together at the factory. The sealed sections 32 are then transported to the worksite by truck 60A. As shown in FIG. 4, second section 32B may be connected to first section 32A while first section 32A is still located on truck 60A to create subassembly 34. Subassembly 34 may then be moved onto foundation 20 using a crane (not shown). In the embodiment shown in FIG. 4, second section 32A is rotated with respect to section 32A before connection such that the joints between the elements of each section do not line up, but are 90 degrees from each other. This is done for each succeeding section, as shown in FIG. 1 to provide additional structural strength.

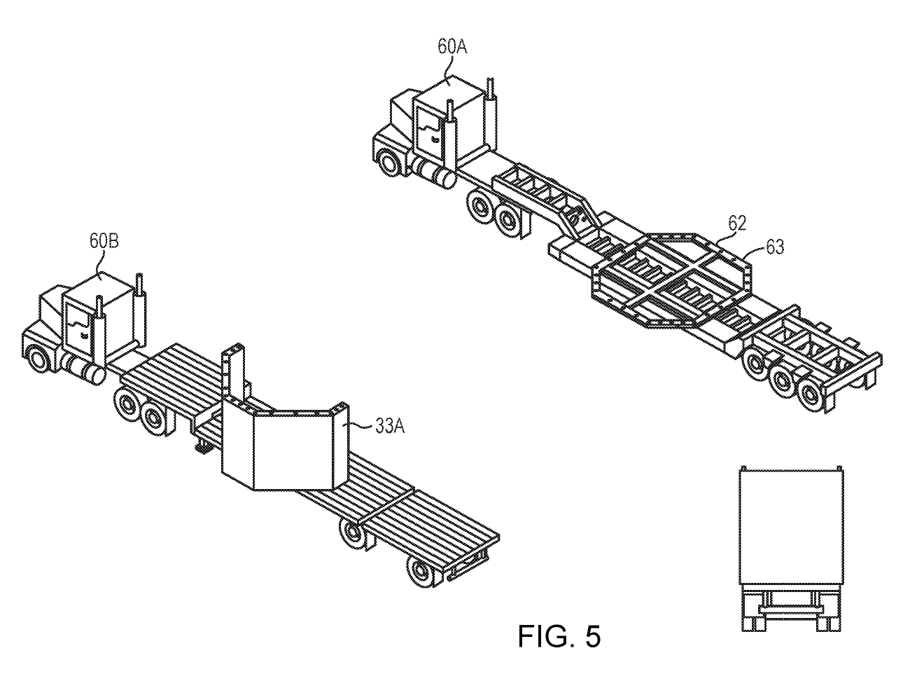

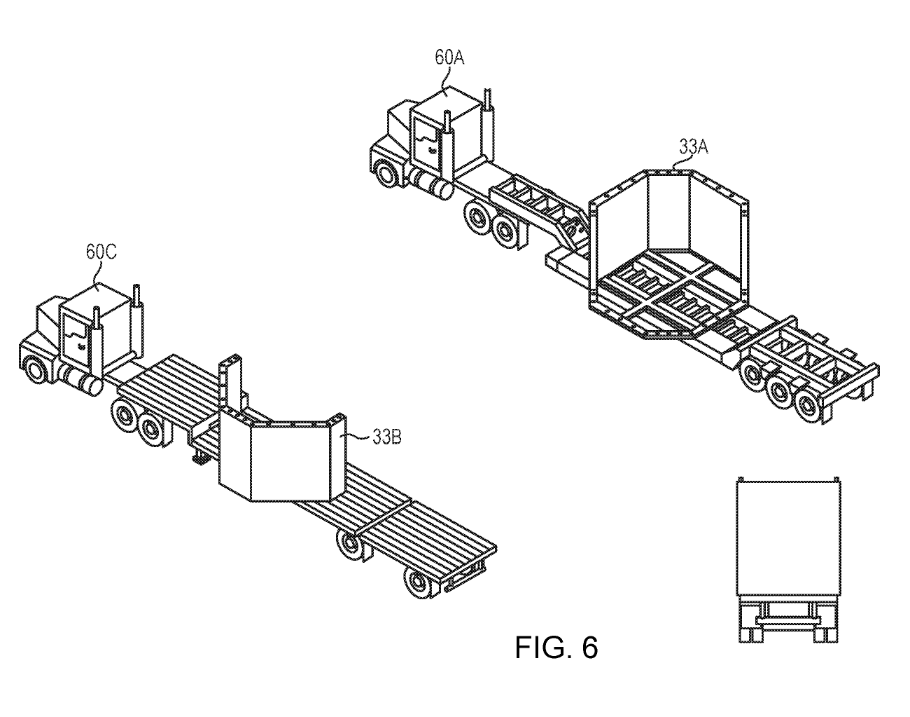

In another embodiment, each section is made of two elements that are transported from the factory separately and then assembled at the worksite. This embodiment is shown in FIG. 5-9. FIG. 5 shows truck 60A with alignment jig 62 mounted on the trailer of the truck 60A. First element 33A is brought in by truck 60B, and element 32A is moved onto alignment jig 62 using a crane (not shown). FIG. 6 shows truck 60C bringing second element 33B, which is also moved onto jig 62 and then attached to element 33B to create a first section 32A.

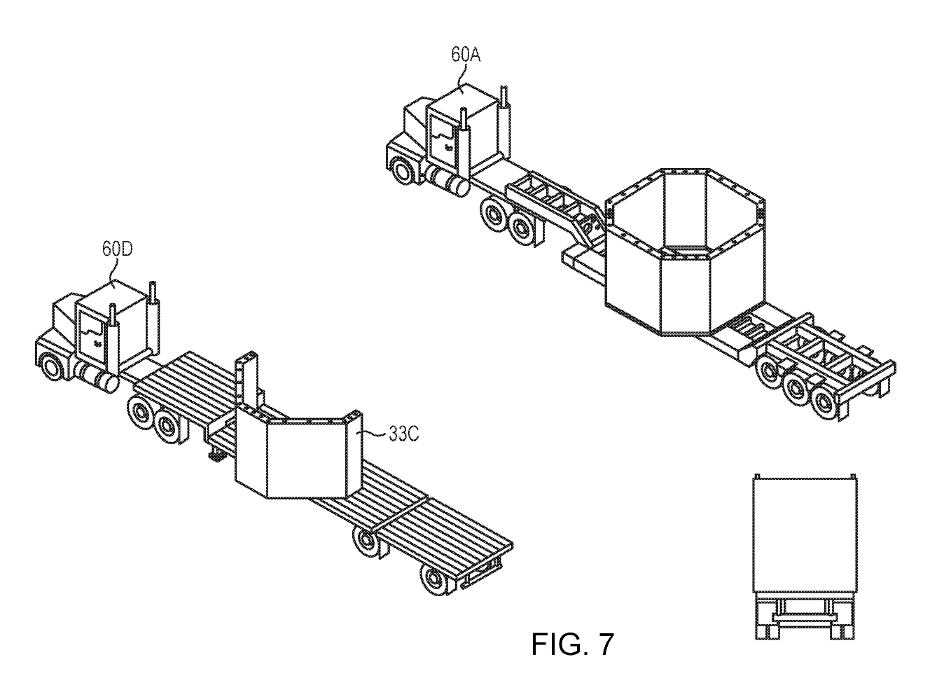

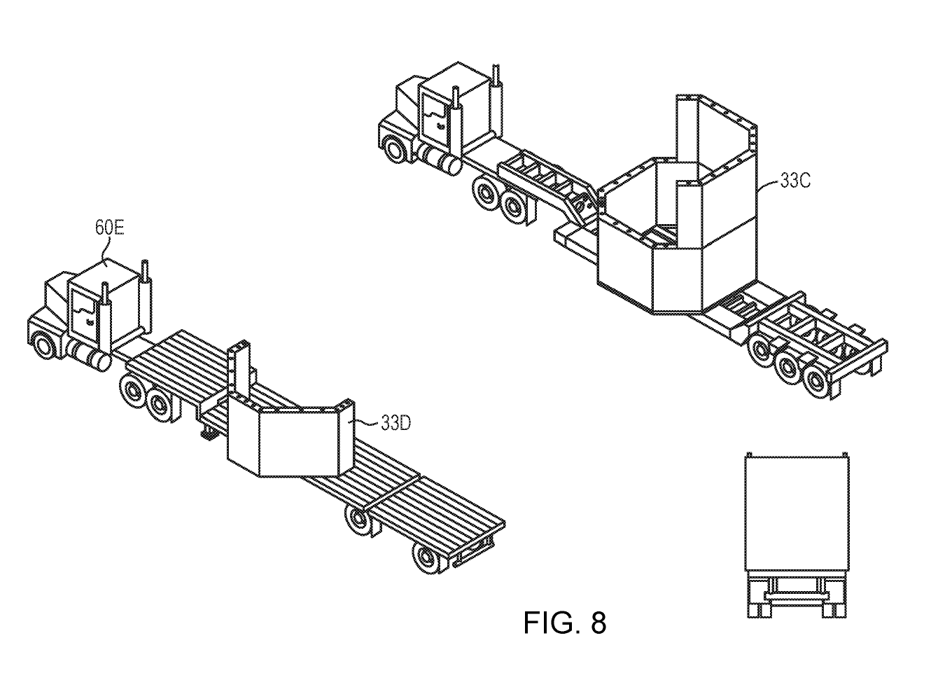

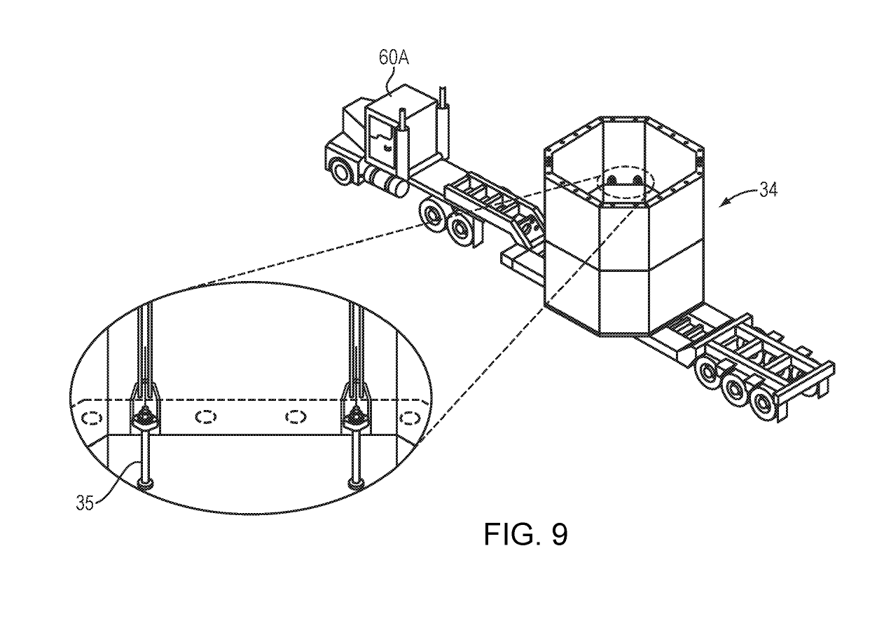

FIG. 7 shows truck 60D bringing element 33C, which is then stacked onto first section 32A by a crane (now shown). Element 33C is placed such that approximately half of element 33C is located on element 33A and half on element 33B. This ensures that the joints between the two sections in the subassembly will be rotated by 90 degrees with respect to each other, as noted above. FIG. 8 then shows element 33D on truck 60E for completion of subassembly 34. FIG. 9 shows completed subassembly 34, along with a close up of the connection between the sections. Rods 35 are used to secure the sections together.

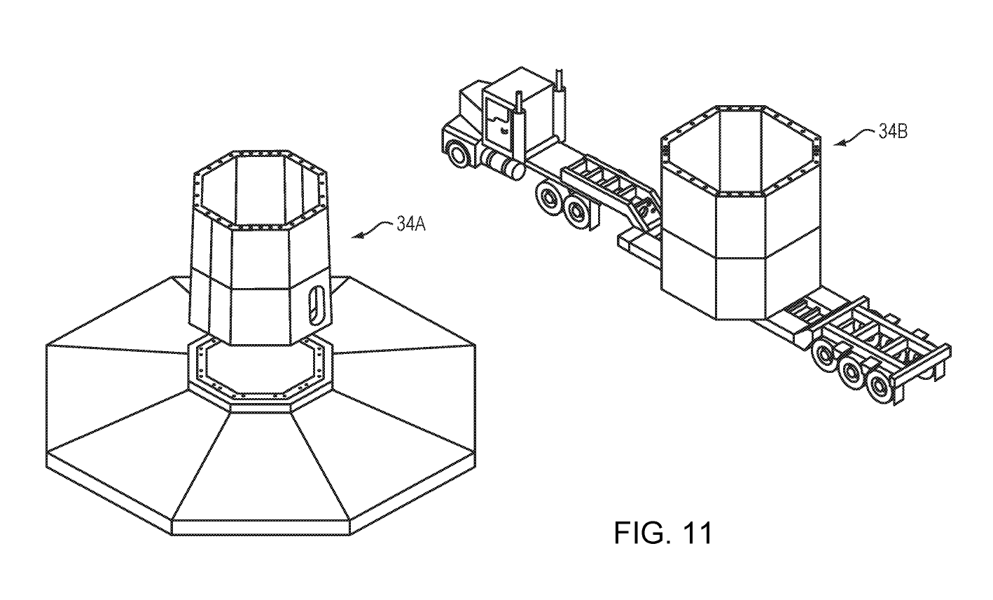

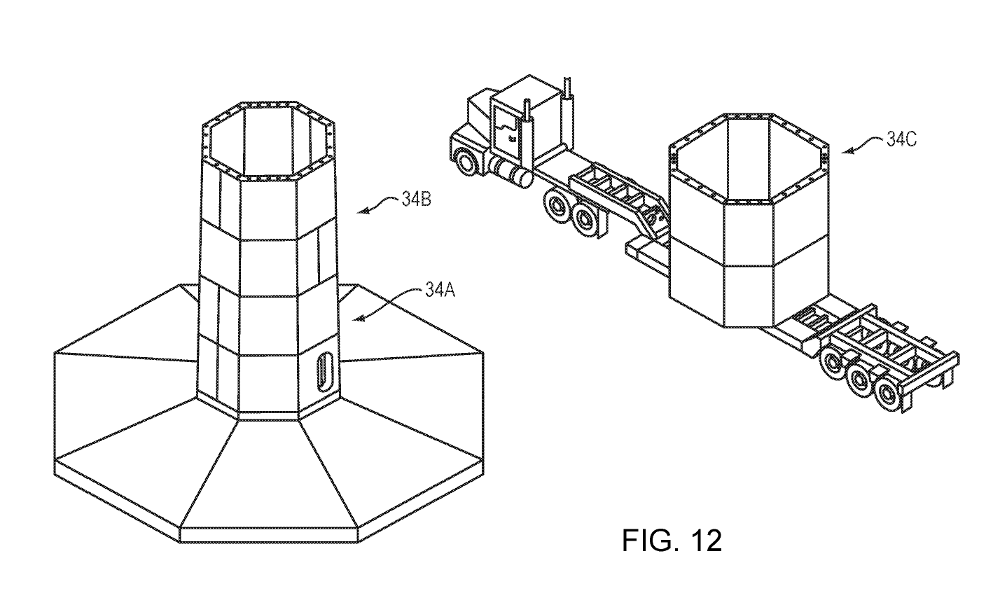

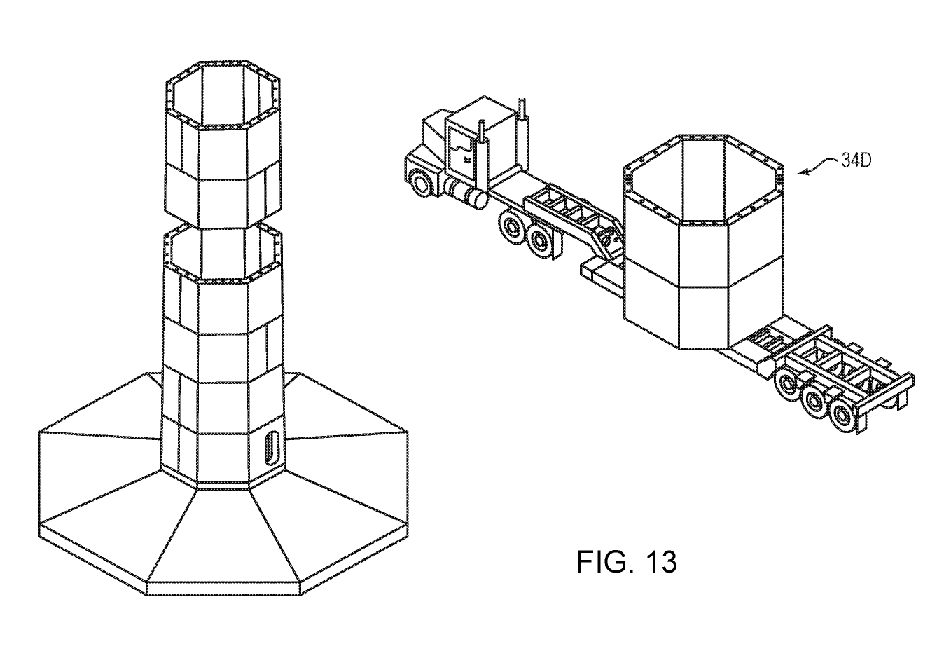

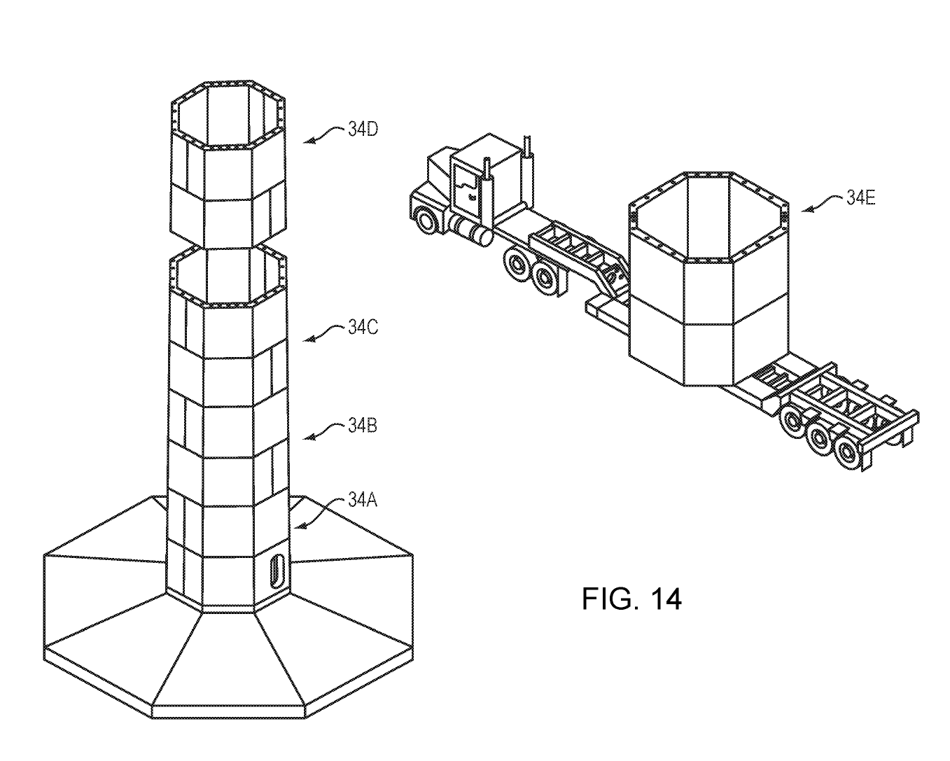

FIG. 10 shows subassembly 34A next to foundation 20. Subassembly 34A is moved onto foundation 20 by a crane (not shown). FIG. 11 shows subassembly 34B is then brought to foundation 20 so that subassembly 34B can be stacked on subassembly 34A. The subassemblies are stacked such that joints between elements in consecutive sections do not line up. FIG. 12 shows subassembly 34C ready to be stacked onto subassembly 34B. Each succeeding subassembly may also have a tapering width, such that the tower becomes narrower as it gets higher. FIGS. 13 and 14 show subassemblies 34D and 34E, which again are successively stacked on foundation 20 to form concrete portion 20 of tower 10.

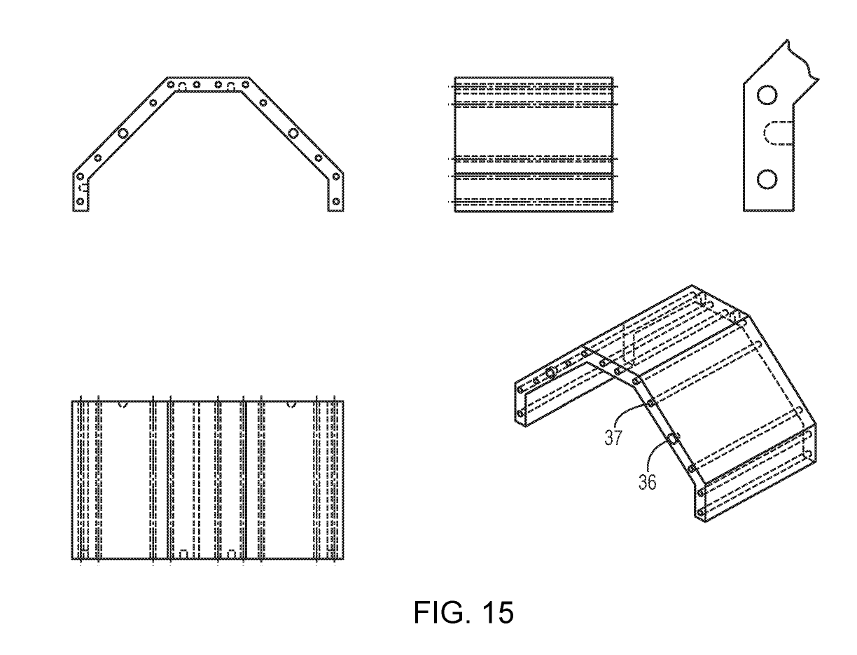

FIG. 15 shows one embodiment of the elements 32. Elements 32 includes ducts 37 through which post-tensioning strands 22 pass. They also include openings 36 through which rods 35 pass. Alignment jig may include pegs 63 (labeled in FIG. 5) which enter openings 36 and ducts 37 to hold the elements 32 on the jig 62.

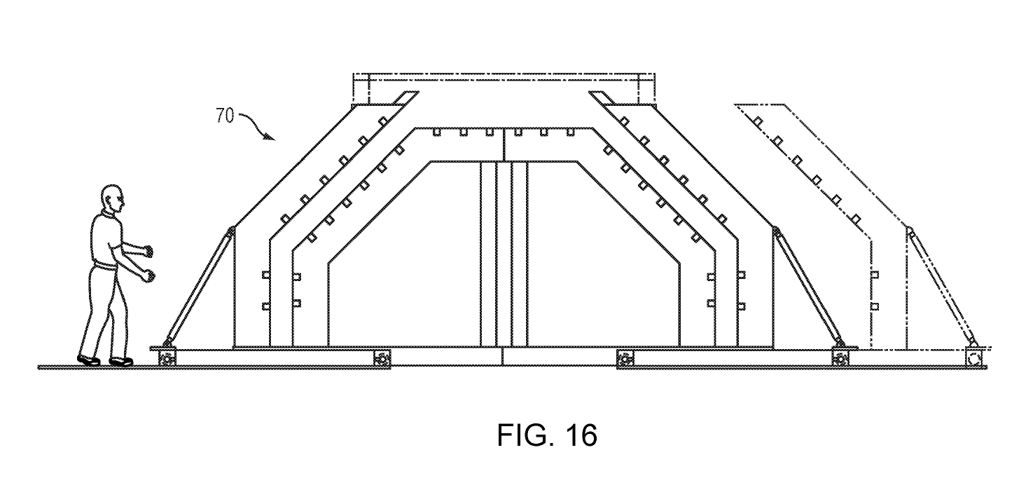

FIG. 16 shows an embodiment of a form 70 for creating elements 32. In this embodiment, the arms of the element 32 are facing down. However, alternate embodiments forming the element in any configuration are also within the scope of the invention.

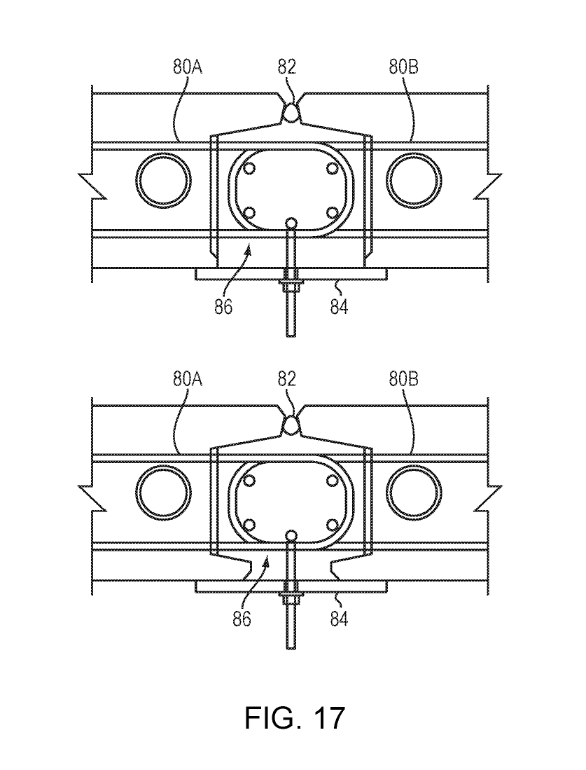

FIG. 17 shows two exemplary embodiments for fastening the elements 32 together. In each of the embodiments shown, rebar 80A and 80B extend from the opposing ends of the adjacent elements into an open space. One side of the open space is sealed with a caulked joint 82. The other side of the open space is sealed with plate 84. The open space is then filled with a grout to join the elements together.

In another embodiment, the elements in a section may be joined with a grout joint as shown in FIG. 17 on one side of the section 32, but only sealed with a waterproof adhesive on the other side. Thus, only the grout joint will bear any significant load, as the waterproof adhesive cannot bear any significant structural load. This may be done because structural connections between joints are required to be certified, which is both costly and time consuming. Structural connections must be able to withstand compression, tension and shear loads, with a minimum factor of safety. In an exemplary embodiment, the number of areas which need to be certified is advantageously minimized. The grouted joints are structurally fastened together, but the adhesive joints have no structural connection between elements. Further, the sections 32 are rotated such that the adhesive joints are staggered as you go up the tower. That is, the adhesive joint for two consecutive sections 32 are not facing the same direction. This provides further structural strength for the tower.

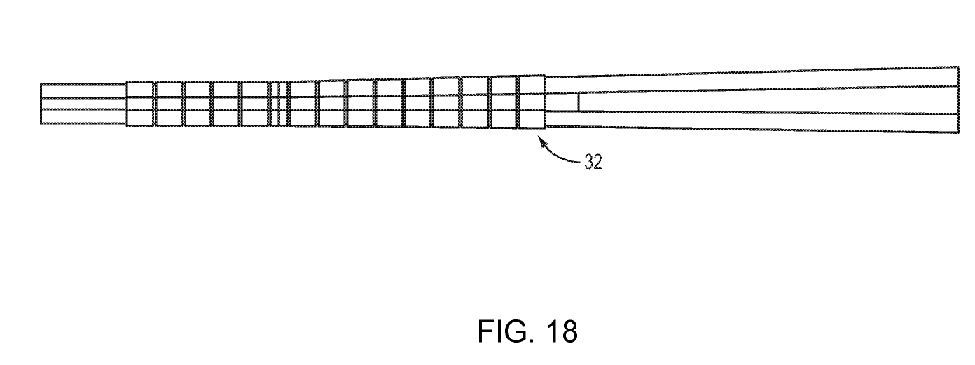

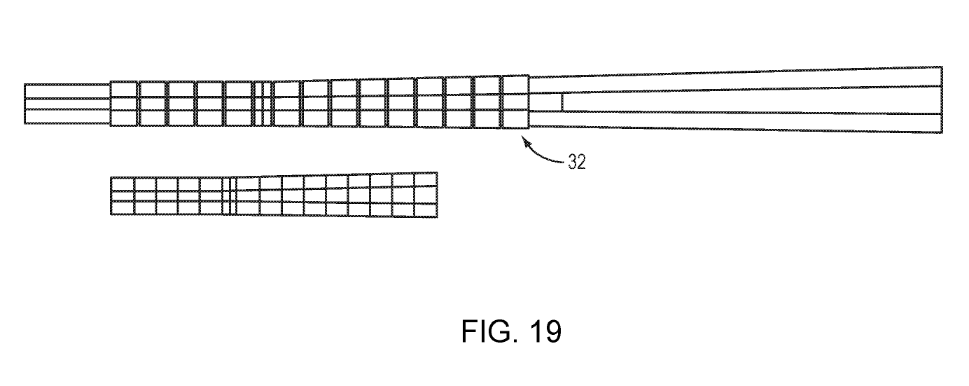

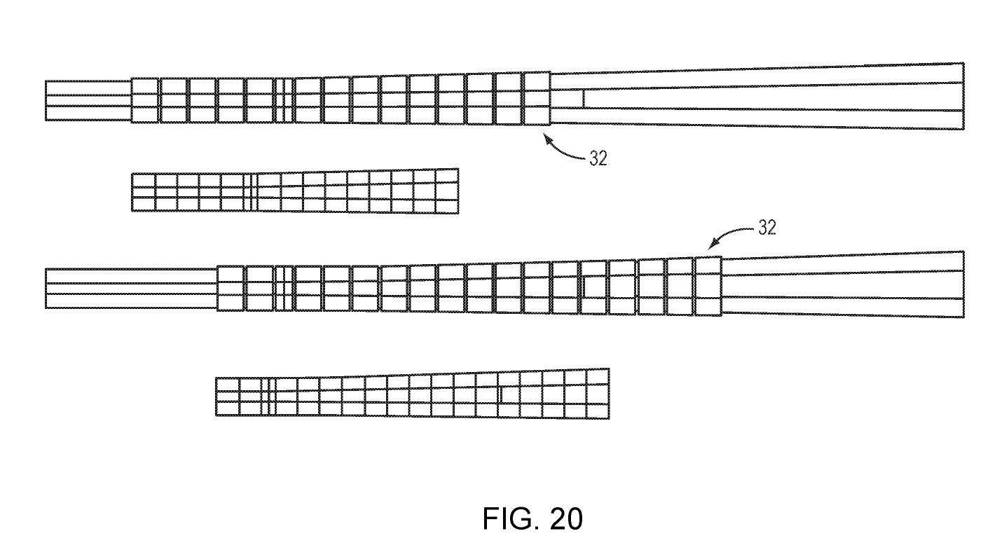

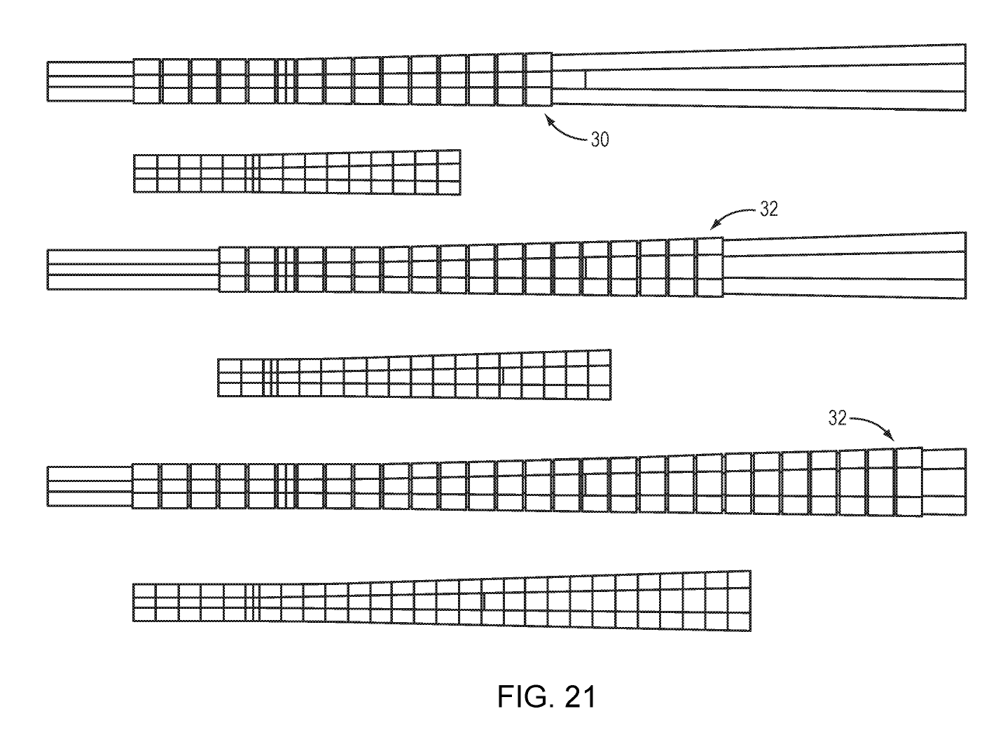

FIGS. 18-21 shows a plurality of configurations that can be made in accordance with the present invention. FIGS. 18 and 19 show towers with 15 sections 32, some of which taper and some of which have straight sides. FIG. 20 shows a tower with 15 sections 32 and a tower with 18 sections 32. FIG. 21 shows three exemplary tower configurations, one with 15 sections 32, one with 18 sections 32, and one with 28 sections 32. All of these embodiments are within the scope of the invention as claimed.

The present written description uses examples to disclose the present subject matter, including the best mode, and also to enable any person skilled in the art to practice the present subject matter, including making and using any devices or systems and performing any incorporated and/or associated methods. While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A tower construction apparatus comprising:
an alignment jig; and
a pre-cast concrete element located on the alignment jig.

2. The tower construction apparatus according to claim 1, wherein the alignment jig includes a plurality of pegs each projecting upward from a top surface of the alignment jig, the pre-cast concrete element includes a plurality of openings, and the pre-cast concrete element is located on the alignment jig such that each of the plurality of pegs extends into one of the plurality of openings.

3. The tower construction apparatus according to claim 1, further comprising:
a second pre-cast concrete element located on the alignment jig.

4. The tower construction apparatus according to claim 3, wherein a first end of the pre-cast concrete element is adjacent a first end of the second pre-cast concrete element, and a second end of the pre-cast concrete element is adjacent a second end of the second pre-cast concrete element.

5. The tower construction apparatus according to claim 4, wherein a first rebar extends from the first end of the pre-cast concrete element and a second rebar extends from the first end of the second pre-cast concrete element.

6. The tower construction apparatus according to claim 5, further comprising:
a caulked joint located between the first end of the pre-cast concrete element and the first end of the second pre-cast concrete element along one side of the first rebar and the second rebar;
a plate extending between the first end of the pre-cast concrete element and the first end of the second pre-cast concrete element along an opposite side of the firs rebar and the second rebar; and
a grout joint surrounding the first rebar and the second rebar and extending between the caulked joint and the plate.

7. The tower construction apparatus according to claim 5, further comprising:
a waterproof adhesive located between the second end of the pre-cast concrete element and the second end of the second pre-cast concrete element.

8. The tower construction apparatus according to claim 3, further comprising:
third and fourth pre-cast concrete elements located on the pre-cast concrete element, and the second pre-cast concrete element; and
rods extending vertically to connect the third and fourth pre-cast concrete elements to the pre-cast concrete element and the second pre-cast concrete element.

9. A method comprising:
providing a foundation;
providing an alignment jig;
assembling a first and a second pre-cast concrete element together on the alignment jig to create a tower section; and
transferring the tower section onto the foundation.

10. The method according to claim 9, wherein the alignment jig includes a plurality of pegs each projecting upward from a top surface of the alignment jig and each of the first and second pre-cast concrete elements include a plurality of openings, and the method further comprises:
placing the first pre-cast concrete element on the alignment jig such that at least one of the plurality of pegs extends into as least one of the plurality of openings in the first pre-cast concrete element; and
placing the second pre-cast concrete element on the alignment jig such that at least one of the plurality of pegs extends into at least one of the plurality of openings in the second pre-cast concrete element.

11. The method according to claim 9, further comprising:
placing the first and second pre-cast concrete elements on the alignment jig such that a first end of the first pre-cast concrete element is adjacent a first end of the second pre-cast concrete element, and a second end of first pre-cast concrete element is adjacent a second end of the second pre-cast concrete element.

12. The method according to claim 11, wherein a first rebar extends from the first end of the first pre-cast concrete element and a second rebar extends from the first end of the second pre-cast concrete element.

13. The method according to claim 12, further comprising:
providing a caulked joint between the first end of the first pre-cast concrete element and the first end of the second pre-cast concrete element along one side of the first rebar and the second rebar;
providing a plate extending between the first end of the first pre-cast concrete element and the first end of the second pre-cast concrete element along an opposite side of the first rebar and the second rebar; and
providing a grout joint surrounding the first rebar and the second rebar and extending between the caulked joint and the plate.

14. The method according to claim 13, further comprising:
providing a waterproof adhesive located between the second end of the first pre-cast concrete element and the second end of the second pre-cast concrete element.
